(19) United States
(12) Patent Application Publication
(10) Pub. No.: US 2007/0243116 A1
(43) Pub. Date: Oct. 18, 2007

(54) Metallic substrate system

(76) Inventor: Klaus Mueller-Haas, Auburn Hills, MI (US)

Correspondence Address: Michael T. Raggio;Raggio & Dinnin, P.C., Ste. 410, 2701 Cambridge Court, Auburn Hills, MI, 48326, US

(21) Appl. No.: 11/403,272

(22) Filed: Apr. 13, 2006

(51) Int. Cl. B01D 50/00; B01D 53/34

(52) U.S. Cl. 422/177; 422/180

(57) ABSTRACT

A substrate system for use in an internal combustion engine. The substrate system includes a metallic substrate which is arranged within a thin walled inner tube. The substrate system also includes an outer tube arranged over the inner tube.

### BACKGROUND OF THE INVENTION

1. Field of the Invention

The present invention generally relates to metallic substrates for purification and more particularly relates to such substrates used for catalytic converter systems for exhaust after treatment or conditioning for internal combustion engines.

2. Description of Related Art

Catalytic converters have been known for numerous years. Generally, catalytic converters are used for the reduction of certain pollution components in exhaust gases, especially in exhaust gasses of internal combustion engines. The catalytic converter generally includes a support structure which is provided with a catalytically effective coating. The support structure has a multiplicity of channels through which an exhaust gas can flow. With the catalytic effective coating adhering to the walls of the channels, the structure will effectively remove pollutants from the exhaust gas. Generally, the support structure in many prior art catalytic converters has a honeycomb structure. Many of these honeycomb structures have a body that is in the form of a monolithic body. However, it may be formed of a ceramic material, but generally a metallic material is used to create the honeycomb bodies of the prior art catalytic converters.

Many apparatuses are known in the prior art for producing such honeycomb bodies. Generally, these apparatuses comprise a fork winding device which engages a stack of metal substrates and rotates them about an axis, which forms segments which when closed constitute a honeycomb body. The honeycomb bodies are then arranged within a tubular jacket and secured thereto. Many of these prior art catalytic converters are thermal insulated which requires additional packaging space in the vehicle. Furthermore, many of the prior art catalytic converters have a long cycle time and use high cost materials and need high cost labor to assemble the converters.

Therefore, there is a need in the art for an improved metallic converter system that includes a metallic substrate. There also is a need in the art for an improved metallic converter system that includes an inner tube and outer tube arranged around a substrate. There is a need in the art for a metallic converter system that will minimize thermal mass on the inner tube to minimize stress due to thermal expansion differences between the substrate matrix and the inner tube. There also is the need in the art for a metallic converter system that is lower in cost to manufacture and has a reduced package size. Furthermore, there is a need in the art for a metallic converter system that includes a predetermined size gap between an inner and outer tube to provide a thermal insulation between the tubes.

### SUMMARY OF THE INVENTION

One object of the present invention may be to provide an improved metallic substrate or converter system.

Another object of the present invention may be to provide a metallic substrate system that is easier to manufacturer and lower in cost.

Yet a further object of the present invention may be to provide a metallic substrate system that includes an outer tube arranged around an inner tube which is arranged around a substrate.

Still a further object of the present invention may be to provide an inner tube that is engineered with a thin wall/minimum thermal mass to minimize stress due to thermal expansion differences between the substrate and inner tube.

Still another object of the present invention may be to provide a mechanical fastening or fixing of the inner and outer tube on one or both ends thereof.

Still another object of the present invention may be to provide for differential expansion of the outer and inner tube due to differential temperatures by only fastening on one end thereof.

Still another object of the present invention may be to provide an air gap between the inner and outer tube to provide a thermal installation barrier between the inner tube and outer tube, therefore reduce surface temperature level.

Still another object of the present invention may be to provide a swaged outer tube or downsized radius inner tube.

To achieve the foregoing objects, a substrate system for use in an exhaust system is disclosed. The substrate system includes a metallic substrate and an inner tube arranged over the metallic substrate. The substrate system also includes an outer tube arranged over the inner tube.

One advantage of the present invention is that it may provide an improved metallic substrate system.

Still another advantage of the present invention may be that it provides an improved metallic substrate or converter system that uses less material and weighs less than prior art converter systems.

Still another advantage of the present invention may be that it reduces the material costs and cost of manufacturing the metallic substrate system.

Still another advantage of the present invention may be that it will reduce the process time for activating the substrate matrix.

Still another advantage of the present invention is that it may provide a thin inner tube brazed to a substrate to allow for quicker temperature changes than prior art converter systems.

Another advantage of the present invention is that it may shrink the overall package size of the substrate system.

Other objects, features and advantages of the present invention will become apparent from the subsequent description and the appended claims, taken in conjunction with the accompanying drawings.

### BRIEF DESCRIPTION OF THE DRAWINGS

FIG. 1 shows an exploded view of the metallic substrate system according to the present invention.

FIG. 2 shows a perspective view of the substrate system according to the present invention with a cutout removed from one portion thereof.

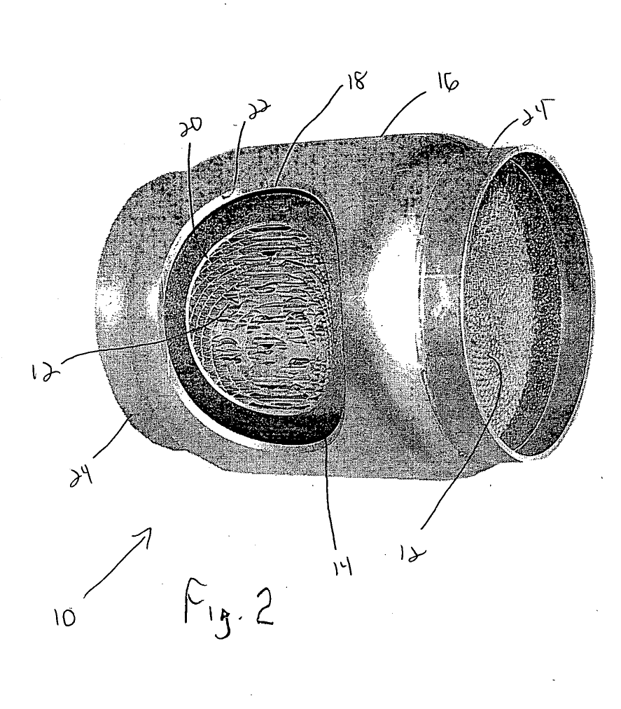

### DESCRIPTION OF THE EMBODIMENT(S)

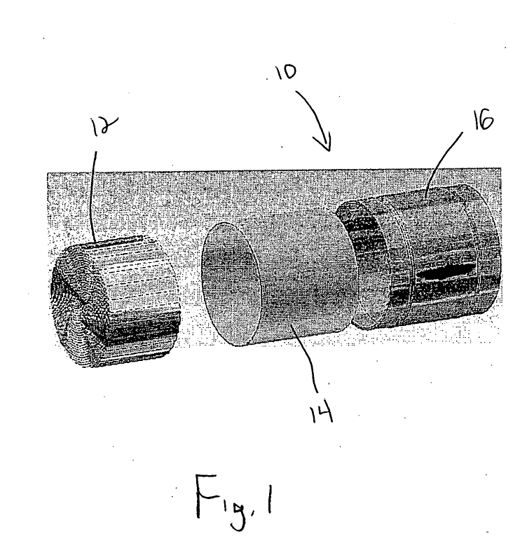

Referring to the drawings, the present invention of a metallic substrate system 10 for use in an exhaust system is shown. FIG. 1 shows an exploded view of the metallic substrate or converter system 10 according to the present invention. The metallic substrate system 10 includes a metallic substrate 12 that is arranged within an inner tube 14. The inner tube 14 and substrate 12 is then arranged within an outer tube 16. It should be noted that the substrate 12 shown is a metallic substrate 12, however any other known substrate may be used with the present invention including but not limited to ceramic substrates, plastic substrates, composite substrates, or any other known material that is capable of being a substrate in a converter or substrate system. It should also be noted that the inner 14 and outer tubes 16 are generally made of a steel material, however any other metal, ceramic, plastic, composite, or natural material may be used for the tubes depending on the design requirements and environment for the metallic substrate system 10 according to the present invention. It is contemplated to use the present invention on any known internal or external combustion engine including but not limited to gasoline, diesel, natural gas, etc., and any other type of internal combustion engine or any known exhaust system using any known fuel type. The substrate or converter system 10 can be made to accommodate any known size by adjusting the overall diameter of the substrate or converter system 10 and the length of the converter system 10 along with adjusting the thicknesses of the substrate 12 and associated tubes 14, 16.

FIG. 1 shows a metallic substrate or matrix 12 in the general form of a honeycomb body. The substrate 12 generally has a cylindrical shape. It should be noted that any other known shape may also be used for the substrate 12. The substrate 12 is generally formed from a plurality of metal sheets. The metal sheets may be flat or corrugated and arranged in any known pattern, i.e., alternating, non-alternating, etc., or the like. The metal sheets are generally coated with a catalytically active material. The coating may be provided on one side of the metal sheets or on both sides of the sheets depending on the design requirements. It should also be noted that the efficiency of the configuration of the substrate 12 may be increased with perforation orifices, which are not specifically illustrated here, especially when the catalytically active coating is placed on both sides of the metal sheet. Generally, the metal sheets are stacked in predetermined configurations or patterns and then spirally wound to create a generally cylindrical shape for the substrate 12. The winding of the metal sheets to form the substrate body 12 may be done by any known method but in particular methods disclosed in Applicant's previously issued U.S. Pat. Nos. 6,049,961 and 6,049,980 are typically used. These two patents are hereby incorporated by reference. It should be noted that any other methodology known for creating substrates may also be used according to the present invention. The metallic substrate 12 is formed such that it will have an outer diameter that is approximately equal to the inner diameter of the inner tube 14 of the substrate system 10. The substrate 12, after being formed into its generally cylindrical shape, is then brazed to the inside surface of the inner tube 14.

The inner tube 14 has a predetermined length and diameter which is capable of being changed depending on the design requirements and the environment in which the substrate system 10 will be operated. The inner tube 14 generally is a thin walled inner tube 14 that has a predetermined thickness 20. The thickness is generally less than one millimeter for the wall of the inner tube 14. In one embodiment contemplated the thickness is approximately 0.5 millimeters for the inner tube 14. This thickness 20 is less than that of prior art converter systems and less than the outer tube 16. The thin walled inner tube 14 having a reduced thickness gives the inner tube 14 a minimal thermal mass. This minimum thermal mass will minimize stress due to the thermal expansion difference between the substrate matrix 12 and the inner tube 14. The use of the thin inner tube 14 will generally increase the life time of the substrate system 10 by approximately a factor of three to four due to the substrate 12 being brazed to the inside surface of the inner tube 14 which will reduce the thermal expansion difference during cycling of the substrate system 10 because the thin inner tube 14 is more capable of following the temperature differences of the substrate 12 in a shorter amount of time than a more thermal or heavier/thicker inner tube as used in the prior art. The metallic substrate 12 is brazed to the inner surface of the inner tube 14 with any known brazing alloy. It is also contemplated to have the inner tube 14 with a reduced diameter midsection (not shown) that will allow for a downsizing of the inner tube 14 from predetermined diameter outer ends. This downsizing of the inner tube 14 may be used to create a gap 18 filled with air between the inner tube 14 and outer tube 16. This gap 18 will provide a thermal insulation for the substrate system 10 such that thermal management is easier to control for the substrate system 10. The substrate 12 generally does not extend all the way to the end of the inner tube 14 but leaves a predetermined space between the end of the inner tube 14 and the end of the substrate 12. However, it should be noted that the substrate 12 can completely fill the bore of the inner tube 14 if the design requirements so require. The inner tube 14 and substrate 12 after being brazed to one another is then arranged within the bore of the outer tube 16.

The outer tube 16 generally has a predetermined diameter and length. The length generally is a predetermined amount greater than the overall length of the inner tube 14. Therefore, there is a predetermined distance between the end of the outer tube 16 and the end of the inner tube 14 that is arranged within the outer tube 16. This distance will allow for the outer tube 16 to be connected via any known mechanical or chemical fastening technique to exhaust tubes or exhaust cones, or the like depending on the design requirements and environment in which the substrate system 10 is used. The outer tube 16 generally has a thickness 22 that is equal to or greater than 1.5 millimeters. In one contemplated embodiment the thickness 22 of the outer tube 16 is approximately 1.5 millimeters. This thickness 22 will allow for the outer tube 16 to absorb any mechanical stresses induced by the interface between exhaust cones or exhaust pipes and the substrate system 10. Generally, these interfaces are in the form of a mechanical or chemical fastening methodology such as welding, soldering or the like. Therefore, the greater the thickness 22 of the outer tube 16 the more it will reduce the mechanical stresses and increase the life of the substrate system 10 in comparison to prior art converter systems. The outer tube 16 is mechanically fixed or chemically fixed via any known fastening technique to the outer surface of the inner tube 14 at the inner surface of the outer tube 16. The outer tube 16 may be fixed to the inner tube 14 on both ends of the inner tube 14 and outer tube 16 or on just one of the ends of the inner tube 14 and outer tube 16. Generally, the mechanical fastening technique used to fix or secure the inner tube 14 to the outer tube 16 is welding, however any other known technique may also be used. When the inner tube 14 and outer tube 16 are mechanically fixed on only one end or side thereof this will allow the substrate system 10 to have differential expansion of the outer tube 16 and the inner tube 14 with respect to one another due to differential temperatures within the inner tube 14 and outer tube 16. The mechanically fixing of the outer tube 16 to the inner tube 14 on both ends or sides thereof is also contemplated for use in the present invention.

The outer tube 16 and inner tube 14 may have a decoupling effect or gap 18 arranged between the inner surface of the outer tube 16 and the outer surface of the inner tube 14. This gap 18 will be filled with air or any other known gas and will provide a thermal insulation barrier between the inner tube 14 and the outer tube 16. The gap 18 can be created by using a swaged outer tube 16 that generally has reduced diameter ends 24 that generally are the same as or mate with the outer diameter of the inner tube 14. The outer tube 16 will be fixed mechanically to the inner tube 14 at these reduced diameter ends 24 via welding or any other known fastening technique. However, it is also contemplated to have a downsized inner tube 14 wherein the outer tube 16 has a fixed diameter for the entire length thereof and the inner tube 14 has a reduced diameter middle portion with its ends having a greater diameter than that of the middle portion. Either way will create a predetermined air gap 18 between the outer tube 16 and inner tube 14 to create a thermal management system for the substrate system 10. In one embodiment contemplated and shown in the drawings a four millimeter air gap 18 is provided between the inner tube 14 and outer tube 16. However, it should be noted that a gap 18 in the range of 0.1 millimeter up to 25 millimeter may be used depending on the design requirements and environment for the substrate system 10. It is also contemplated to have no gap 18 between the inner tube 14 and the outer tube 16.

It should be noted that prior art metallic substrates generally were engineered into thick inner tubes and then a heat shield was placed on top of the inner tube wherein the heat shield was welded to the top portion of the substrate inner tube or mantle. The present invention will reduce the thickness of the inner tube 14 while using a generally thicker outer tube 16 to create a longer life and more durable substrate system 10 than those of the prior art. The use of the thin walled inner tube 14 and the predetermined thickness outer tube 16 will allow for reduced weight and reduced raw materials in the substrate system 10. This will make the substrate system 10 less costly to produce while also reducing processing time for activating the catalytic coating on the substrate 12 because of the reduced time needed for the inner tube 14 to follow the temperature cycles of the substrate system 10 and in particular the metallic substrate 12. Therefore, the substrate system 10 is much more cost effective to use than those of prior art converter systems.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

What is claimed is:

1. A substrate system for use in an exhaust system, said substrate system comprising:
a metallic substrate;
a thin walled inner tube arranged over said metallic substrate; and
an outer tube arranged over said inner tube.

2. The substrate system of claim 1 wherein said substrate is brazed within said inner tube.

3. The substrate system of claim 1 wherein said inner tube is made of a metal material and is approximately 0.5 mm thick.

4. The substrate system of claim 1 wherein said inner tube has a predetermined thermal mass which minimizes stress due to thermal expansion differences between said substrate and said inner tube.

5. The substrate system of claim 1 wherein said outer tube is secured to exhaust pipes or cones on each end thereof and said outer tube is approximately 1.5 mm thick.

6. The substrate system of claim 5 wherein said outer tube reduces mechanical stresses induced by said interface with said exhaust pipes or cones in the exhaust system.

7. The substrate system of claim 1 wherein said inner tube and said outer tube are mechanically fixed to one another on one end thereof.

8. The substrate system of claim 7 wherein said one fixed end allows for differential expansion of said outer tube and said inner tube due to different temperatures thereof.

9. The substrate system of claim 1 wherein said outer tube and said inner tube are mechanically fixed to one another on both ends.

10. The substrate system of claim 1 further including a gap between an outer surface of said inner tube and an inner surface of said outer tube.

11. The substrate system of claim 10 wherein said gap is filled with air and provides thermal insulation between said inner tube and said outer tube.

12. The substrate system of claim 10 wherein said gap is approximately within the range of 1 mm to 10 mm.

13. The substrate system of claim 10 wherein said outer tube having reduced diameter ends.

14. The substrate system of claim 10 wherein said inner tube having a reduced diameter middle portion.

15. The substrate system of claim 1 wherein said substrate is coated with a predetermined catalyst agent.

16. A metallic converter system for use in an exhaust system of a vehicle, said converter system compromising:
a metallic substrate having a generally tubular shape;
a thin walled inner tube having a predetermined length and diameter, said substrate is brazed to a surface of said inner tube; and
an outer tube having a predetermined length and diameter, said outer tube connected to an outer surface of said inner tube.

17. The converter system of claim 16 wherein said outer tube is connected to said inner tube on one end thereof, said inner tube having a thickness less than 1 mm and said outer tube having a thickness greater than or equal to 1.5 mm.

18. The converter system of claim 16 wherein said outer tube is connected to said inner tube on both ends thereof, said inner tube having a thickness less than 1 mm and said outer tube having a thickness greater than or equal to 1.5 mm.

19. The converter system of claim 16 further including a gap between an inner surface of said outer tube and said outer surface of said inner tube, said gap is approximately 4 mm.

20. The converter system of claim 19 wherein said outer tube having reduced diameter ends that are substantially equal to a diameter of said inner tube.
